(19) United States
(12) Patent Application Publication
(10) Pub. No.: US 2010/0007045 A1
(43) Pub. Date: Jan. 14, 2010

(54) METHOD FOR MANUFACTURING SHELL WITH TEXTURED APPEARANCE

(75) Inventors: CHE-YUAN HSU, Shindian (TW); CHENG-WEN SU, Shindian (TW); GANG HUANG, Shenzhen City (CN); YAN-MIN WANG, Shenzhen City (CN); QIANG WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/498,450

(22) Filed: Jul. 7, 2009

(30) Foreign Application Priority Data
Jul. 10, 2008 (CN) 200810302680.7

(51) Int. Cl. B29C 33/38

(52) U.S. Cl. 264/219

(57) ABSTRACT

A method is provided for manufacturing a shell with a textured appearance as follows. A mold formed with a textured mold portion is provided. A film is provided into the mold and in contact with the textured mold portion. The shell is formed by injecting a plastic material into the mold to push the film further into the textured mold portion.

### BACKGROUND

1. Technical Field

The present disclosure relates to a method for manufacturing a shell with a textured appearance.

2. Description of Related Art

With the development of surface treatment technology, it is feasible to decorate the shells for portable electronic devices, such as by texturing the shells. A textured appearance can be achieved by an implementing of an extra surface treatment, such as with a laser to etch a previous molded shell. However, the extra surface treatment usually costs time and money.

Therefore, there is room for improvement within the art.

### BRIEF DESCRIPTION OF THE DRAWING

Many aspects of the new method for manufacturing a shell with a textured appearance can be better understood with reference to the following drawings. The components in the drawings are not necessarily drawn to scale, the emphasis instead being placed upon clearly illustrating the principles of the method for manufacturing a shell with a textured appearance. Moreover, in the drawings, like reference numerals designate corresponding parts throughout the several views.

FIG. 1 is an isometric view of a shell manufactured by a method according to an exemplary embodiment.

FIG. 2 is an isometric view of a mold and a film provided during implementing the method to manufacture the shell shown in FIG. 1.

FIG. 3 is similar to FIG. 2, but showing the molding state of the mold.

### DETAILED DESCRIPTION

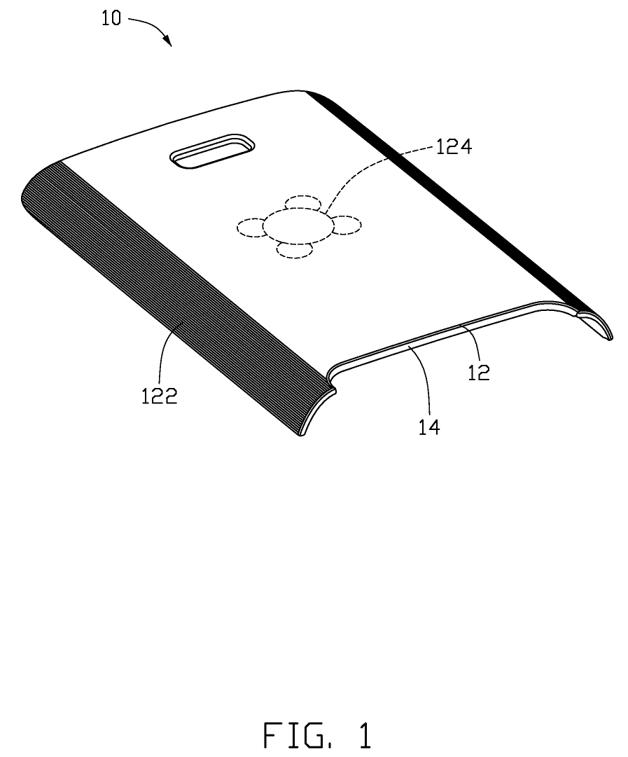

An exemplary manufacturing method is provided for manufacturing a shell 10 (shown in FIG. 1) suitably used in a portable electronic device such as a mobile phone. The exterior surface of the shell 10 can be textured for forming a textured shell portion 12 thereon. The manufacturing method may include the following steps:

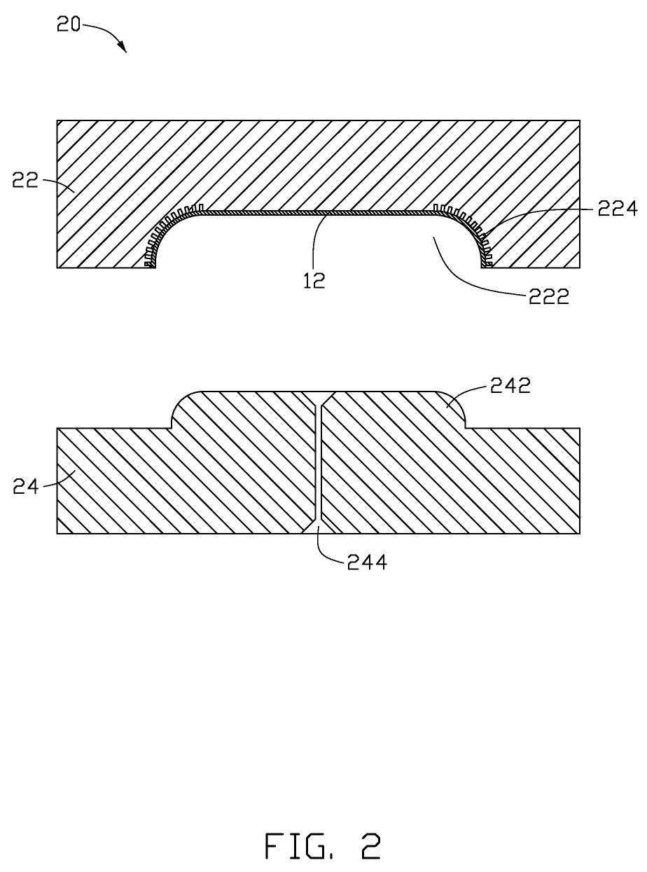

Referring further to FIG. 2, a mold 20 is provided including a female mold 22 and a male mold 24. The female mold 22 defines a mold cavity 222. The interior surface of the mold cavity 222 corresponds to what will ultimately be the exterior surface of the shell 10. The interior surface of the mold cavity 222 has a textured mold portion 224 partially or wholly etched with a laser. The male mold 24 includes a mold core 242 and a flow passage 244 through the mold core 242. The exterior surface of the mold core 242 corresponds to the interior (underneath) surface of the shell 10.

A plastic film 12 is provided and made of a material selected from a group consisting of polycarbonate (PC), polyethylene terephthalate (PET), polymethyl methacrylate (PMMA) or other plastic materials that may be transparent to a degree. The surface of the plastic film 12 has a decorative layer 124 formed thereon for example, the decorative layer 124 can include a colorful pattern or product logo. The decorative layer 124 can be an ink layer fabricated by a typical screen printing.

The plastic film 12 is trimmed into a predetermined two-dimensional shape. The trimmed plastic film 12 is then hot formed into a predetermined three-dimensional shape corresponding to the shell 10.

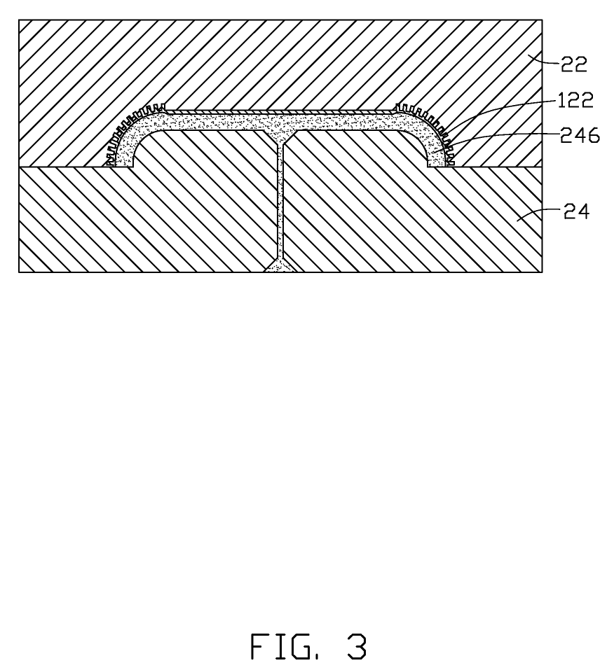

Referring to FIG. 3, the hot-formed plastic film 12 is insert-molded with a base shell 14 into the shell 10. This is done by placing the hot-formed plastic film 12 into the mold cavity 222 with its surface with the decorative layer 124 thereon facing away from the interior surface of the mold cavity 222 and its opposite surface in contact with the interior surface of the mold cavity 222.

The male mold 24 and the female mold 22 is closed and a molten plastic material 246 is injected through the flow passage 244 into the mold cavity 222. The plastic material 246 is selected from a group consisting of Polyethylene (PE), polyamide (PA), polycarbonate (PC), acrylonitrile-butadiene-styrene (ABS), polymethyl methacrylate (PMMA) and polyethylene terephthalate (PET). The injected molten plastic material 246 fills the mold cavity 222 and pushes the opposite surface of the plastic film 12 further into the textured mold portion 224. Thus, the textured shell portion 122 of the shell 10 is physically achieved.

After cooling, the base shell 14 attached to the surface of the film 12 with the decorative layer 124 is formed. The shell 10 can then be taken out by opening the male mold 24 and the female mold 22.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a shell with a textured appearance, comprising:
providing a mold formed with a textured mold portion;
providing a film into the mold and in contact with the textured mold portion;
forming the shell by injecting a plastic material into the mold to push the film further into the textured mold portion.

2. The manufacturing method as claimed in claim 1, wherein the mold comprises a male mold and a female mold, the female mold defines a mold cavity, the textured mold portion is formed in the interior surface of the mold cavity.

3. The manufacturing method as claimed in claim 2, wherein the textured mold portion is formed by a laser etching.

4. The manufacturing method as claimed in claim 2, wherein the film has a decorative layer formed thereon.

5. The manufacturing method as claimed in claim 1, wherein the film is made of a material with a degree of transparency.

6. The manufacturing method as claimed in claim 1, further comprising a, trimming and hot-forming the film into a predetermined shape corresponding to the shell before inserting the film into the mold.

7. The manufacturing method as claimed in claim 1, wherein the film is made of a plastic material selected from a group consisting of polycarbonate (PC), polyethylene terephthalate (PET), polymethyl methacrylate (PMMA).

8. The manufacturing method as claimed in claim 1, wherein the injected plastic material is selected from a group consisting of Polyethylene (PE), polyamide (PA), polycarbonate (PC), acrylonitrile-butadiene-styrene (ABS), polymethyl methacrylate (PMMA) and polyethylene terephthalate (PET).

9. A method for manufacturing a shell with a textured appearance, comprising:
providing a mold formed with a textured mold portion;
providing a film;
trimming the film into a two-dimensional shape corresponding to the shell;
hot-forming the trimmed film into a three-dimensional shape corresponding to the shell;
inserting the hot-formed film into the mold and in contact with the textured mold portion;
injecting a plastic material into the mold to push the film further into the textured mold portion;
cooling the mold to form the shell.

10. The manufacturing method as claimed in claim 9, wherein the mold comprises a male mold and a female mold, the female mold defines a mold cavity, the textured mold portion is formed in the interior surface of the mold cavity.

11. The manufacturing method as claimed in claim 10, wherein the textured mold portion is formed by a laser etching.

12. The manufacturing method as claimed in claim 10, wherein the film has a decorative layer formed thereon, the decorative layer opposite to the textured mold portion.

13. The manufacturing method as claimed in claim 9, wherein the film is made of a material with a certain degree of transparency.

14. The manufacturing method as claimed in claim 9, wherein the film is made of a plastic material selected from a group consisting of polycarbonate (PC), polyethylene terephthalate (PET), polymethyl methacrylate (PMMA).

15. The manufacturing method as claimed in claim 9, wherein the injected plastic material is selected from a group consisting of Polyethylene (PE), polyamide (PA), polycarbonate (PC), acrylonitrile-butadiene-styrene (ABS), polymethyl methacrylate (PMMA) and polyethylene terephthalate (PET).
